(19) United States
(12) Patent Application Publication
(10) Pub. No.: US 2025/0226698 A1
(43) Pub. Date: Jul. 10, 2025

(54) WIRELESS POWER TRANSFER SYSTEM AND POWER TRANSMISSION DEVICE FOR WIRELESS POWER TRANSFER SYSTEM

(71) Applicant: Murata Manufacturing Co., Ltd., Kyoto-fu (JP)

(72) Inventors: Norikazu SAKAMOTO, Nagaokakyo-shi (JP); Tatsuya HOSOTANI, Nagaokakyo-shi (JP)

(73) Assignee: Murata Manufacturing Co., Ltd., Kyoto-fu (JP)

(21) Appl. No.: 19/088,818

(22) Filed: Mar. 24, 2025

Related U.S. Application Data
(63) Continuation of application No. PCT/JP2023/036142, filed on Oct. 4, 2023.

(30) Foreign Application Priority Data
Oct. 21, 2022 (JP) 2022-168780

(51) Int. Cl. H02J 50/12; H02J 50/80

(52) U.S. Cl. CPC H02J 50/12; H02J 50/80

(57) ABSTRACT

A wireless power transfer system includes a power reception device and a power transmission device. The wireless power transfer system performs wireless power supply by forming an electromagnetic resonance field between the power transmission device and the power reception device and performs signal transmission by resonance modulation using the electromagnetic resonance field. The power transmission device includes a power transmission coil that performs wireless power transmission by forming the electromagnetic resonance field, a power transmission circuit including a power transmission resonant circuit, a resonance demodulation circuit that achieves resonance demodulation corresponding to the resonance modulation, a current detection circuit that detects an input current to the power transmission circuit, and a current regulator circuit that adjusts the input current. The power transmission device detects, by using the current detection circuit, a state in which a signal generated by the power reception circuit using the resonance modulation is undetectable.

### CROSS-REFERENCE TO RELATED APPLICATIONS

This application claims benefit of priority to International Patent Application No. PCT/JP2023/036142, filed Oct. 4, 2023, and to Japanese Patent Application No. 2022-168780, filed Oct. 21, 2022, the entire contents of each are incorporated herein by reference.

### BACKGROUND

### Technical Field

The present disclosure relates to a wireless power transfer system that performs communication together with wireless power supply.

### Background Art

Japanese Patent No. 5290014 describes an RFID module. The RFID module described in Japanese Patent No. 5290014 estimates the distance to a reader/writer based on the level of an antenna excitation voltage.

When the antenna excitation voltage exceeds a predetermined threshold, the RFID module described in Japanese Patent No. 5290014 adjusts the phase of a carrier wave.

### SUMMARY

In recent years, the functions and channels of implantable medical devices have increased, leading to higher power consumption and a greater burden on patients due to battery replacements. Therefore, wireless power supply is expected to be adopted for implantable medical devices. Also, in relation to wireless power supply, various technologies for performing communication together with wireless power supply have been devised.

However, when an RFID module as described in Patent Document 1 is used for such communication, there are situations where communication is not possible (i.e., NULL occurs) even within a range in which power sufficient for communication can be received. In particular, when a metal housing is used as in the case of an implantable medical device, communication tends to fail due to the influence of the metal housing.

Accordingly, the present disclosure provides a wireless power transfer system that can stably perform signal transmission within a distance range in which power can be supplied when the signal transmission is performed together with wireless power supply.

A wireless power transfer system according to the present disclosure includes a power reception device and a power transmission device. The wireless power transfer system performs wireless power supply by forming an electromagnetic resonance field between the power transmission device and the power reception device and performs signal transmission by resonance modulation using the electromagnetic resonance field.

The power reception device includes a housing having an internal space, a power reception coil that is disposed in the internal space and performs wireless power reception by forming the electromagnetic resonance field, a power reception circuit including a power reception resonant circuit and a resonance modulation circuit that performs the resonance modulation, and a load circuit that performs a predetermined electric circuit operation using output power of the power reception circuit.

The power transmission device includes a power transmission coil that performs wireless power transmission by forming the electromagnetic resonance field, a power transmission circuit including a power transmission resonant circuit, a power transmission control circuit, a resonance demodulation circuit that performs resonance demodulation corresponding to the resonance modulation, a current detection circuit that detects an input current to the power transmission circuit, and a current regulator circuit that adjusts the input current.

The power transmission device detects, by using the current detection circuit, a state in which a signal generated by the resonance modulation and received from the power reception circuit is undetectable. When the signal is undetectable, the current detection circuit changes the input current by using the current regulator circuit.

With this configuration, the wireless power transfer system prevents the state in which signals are not detectable and thereby stabilizes the operation of resonance demodulation.

The present disclosure makes it possible to stably perform signal transmission in a distance range in which power can be supplied when the signal transmission is performed together with wireless power supply.

### BRIEF DESCRIPTION OF THE DRAWINGS

FIG. 1 is a functional block diagram illustrating an example of a configuration of a wireless power transfer system according to an embodiment of the present disclosure;

FIG. 2 is a functional block diagram illustrating an example of a configuration of a power transmission device according to the embodiment of the present disclosure;

FIG. 3 is a functional block diagram illustrating an example of a configuration of a power reception device according to the embodiment of the present disclosure;

FIG. 4 is a side cross-sectional view illustrating an example of a structure of the wireless power transfer system according to the embodiment of the present disclosure;

FIGS. 5A, 5B, 5C, and 5D are diagrams showing waveforms during demodulation;

FIG. 6 is a diagram illustrating a first example of a current regulator circuit according to the embodiment of the present disclosure;

FIG. 7 is a diagram illustrating a second example of a current regulator circuit according to the embodiment of the present disclosure; and

FIG. 8 is a diagram illustrating an example of a current detection circuit according to the embodiment of the present disclosure.

### DETAILED DESCRIPTION

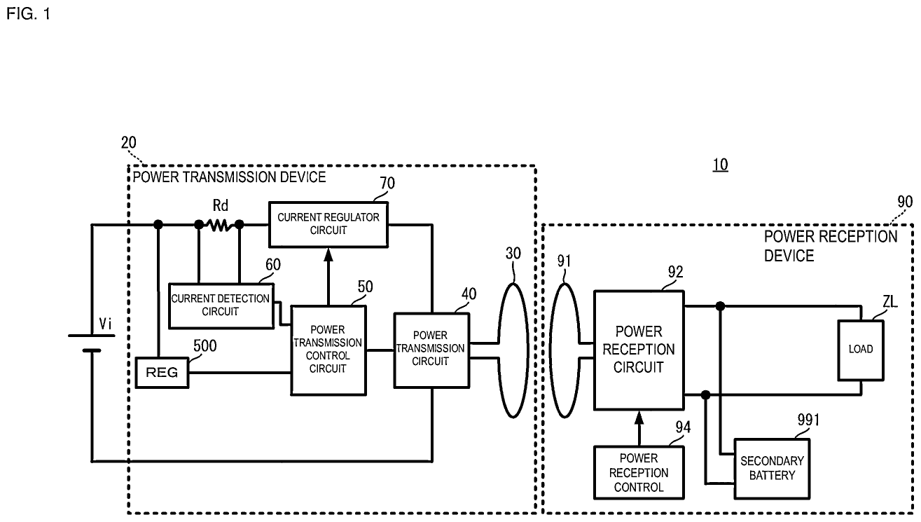

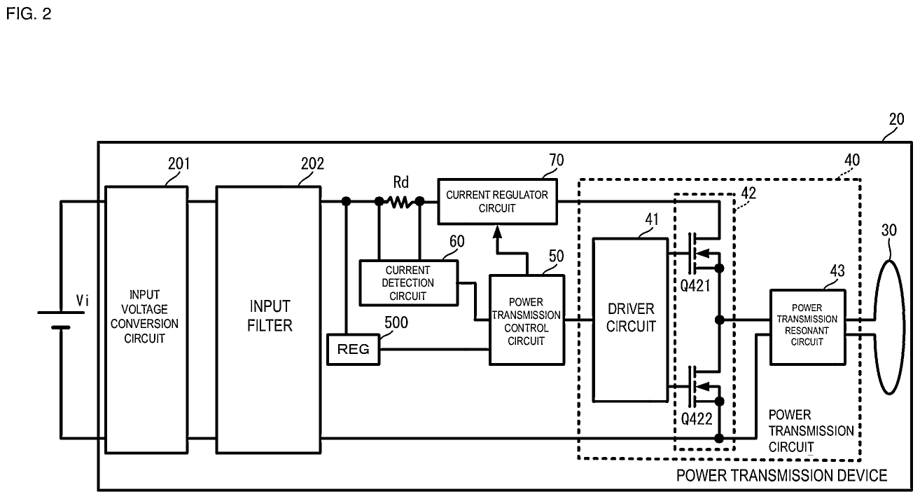

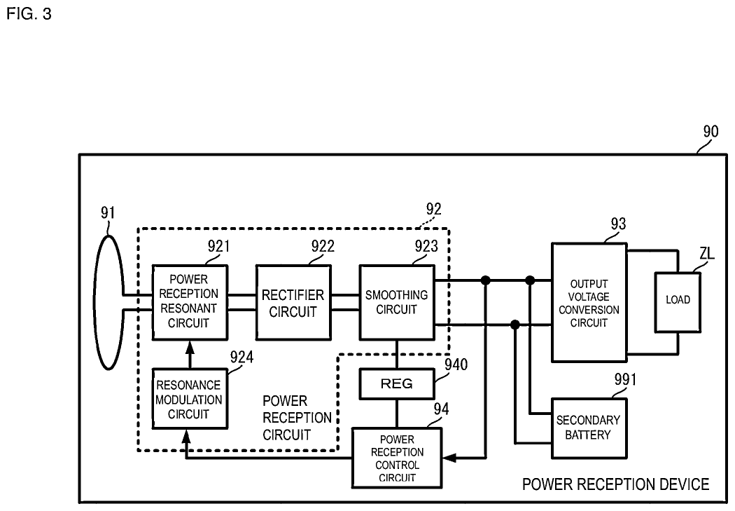

A wireless power transfer system according to an embodiment of the present disclosure is described with reference to the drawings. FIG. 1 is a functional block diagram illustrating an example of a configuration of the wireless power transfer system according to the embodiment of the present disclosure. FIG. 2 is a functional block diagram illustrating an example of a configuration of a power transmission device according to the embodiment of the present disclosure. FIG. 3 is a functional block diagram illustrating an example of a configuration of a power reception device according to the embodiment of the present disclosure. In FIG. 1, a part of the configuration of a power transmission device 20 and a part of the configuration of a power reception device 90 are omitted. The detailed configuration of the power transmission device 20 is illustrated in FIG. 2, and the detailed configuration of the power reception device 90 is illustrated in FIG. 3.

(Schematic Configuration of Wireless power transfer system 10)

As illustrated in FIG. 1, a wireless power transfer system 10 includes a power transmission device 20 and a power reception device 90. The wireless power transfer system 10 forms an electromagnetic resonance field between the power transmission device 20 and the power reception device 90, performs wireless power supply using this electromagnetic resonance field, and also performs signal transmission by resonance modulation using the electromagnetic resonance field.

Specifically, the power transmission device 20 and the power reception device 90 have configurations as described below. With the configurations, the power transmission device 20 and the power reception device 90 perform wireless power supply using an electromagnetic resonance field and also perform signal transmission by resonance modulation using the electromagnetic resonance field.

### (Power Transmission Device 20)

As illustrated in FIGS. 1 and 2, the power transmission device 20 includes a power transmission coil 30, a power transmission circuit 40, a power transmission control circuit 50, a current detection circuit 60, a current regulator circuit 70, an input voltage conversion circuit 201, an input filter 202, and a regulator 500. The power transmission circuit 40 includes a driver circuit 41, a power conversion circuit 42, and a power transmission resonant circuit 43.

Input terminals of an input voltage conversion circuit 201 are connected to a direct-current power supply, and output terminals of the input voltage conversion circuit 201 are connected to input terminals of an input filter 202. Here, the input voltage conversion circuit 201 and the input filter 202 may be omitted.

A high-side output terminal of the input filter 202 is connected to a current detection resistor Rd, and an input terminal of the current regulator circuit 70 is connected to the current detection resistor Rd. An output terminal of the current regulator circuit 70 is connected to a high-side input terminal of the power conversion circuit 42. A low-side output terminal of the input filter 202 is connected to a low-side terminal of the power conversion circuit 42. The specific configuration of the current regulator circuit 70 is described later.

The power conversion circuit 42 includes a high-side switching element Q421 (for example, a power FET) and a low-side switching element Q422 (for example, a power FET). The high-side switching element Q421 and the low-side switching element Q422 are connected between the high-side input terminal and the low-side terminal of the power conversion circuit 42. A node between the high-side switching element Q421 and the low-side switching element Q422 is an output terminal of the power conversion circuit 42.

The output terminal and the low-side terminal of the power conversion circuit 42 are connected to the power transmission resonant circuit 43. The power transmission resonant circuit 43 is connected to the power transmission coil 30.

The power transmission resonant circuit 43 has predetermined capacitance. The capacitance of the power transmission resonant circuit 43 is preferably variable.

The power transmission coil 30 is implemented by a loop-shaped or wound linear conductor. The length and the shape of the power transmission coil 30 are determined such that the power transmission coil 30 can be electromagnetically coupled with the power reception coil 91 of the power reception device 90, and the inductance of the power transmission coil 30 is set such that an electromagnetic resonance field generated between the power reception device 90 and the power transmission device 20 can be formed.

The current detection circuit 60 is connected to both ends of the current detection resistor Rd. An output end of the current detection circuit 60 is connected to the power transmission control circuit 50. The specific configuration of the current detection circuit 60 is described later.

The power transmission control circuit 50 is a digital control circuit, such as an MPU. The power transmission control circuit 50 includes a drive output terminal and a current adjustment output terminal.

The drive output terminal of the power transmission control circuit 50 is connected to the driver circuit 41 of the power transmission circuit 40. Output terminals of the driver circuit 41 are connected to the gate of the high-side switching element Q421 and the gate of the low-side switching element Q422 of the power conversion circuit 42.

The current adjustment output terminal of the power transmission control circuit 50 is connected to the current regulator circuit 70.

The power transmission control circuit 50 is connected via the regulator 500 to a high-side conductive line between the high-side output terminal of the input filter 202 and the current detection resistor Rd.

### (Power Reception Device 90)

As illustrated in FIGS. 1 and 3, the power reception device 90 includes a power reception coil 91, a power reception circuit 92, an output voltage conversion circuit 93, a power reception control circuit 94, a secondary battery 991, a regulator 940, and a load ZL. The power reception circuit 92 includes a power reception resonant circuit 921, a rectifier circuit 922, a smoothing circuit 923, and a resonance modulation circuit 924.

The power reception coil 91 is implemented by a loop-shaped or wound linear conductor. The length and the shape of the power reception coil 91 are determined such that the power reception coil 91 can be electromagnetically coupled with the power transmission coil 30 of the power transmission device 20, and the inductance of the power reception coil 91 is set such that an electromagnetic resonance field generated between the power reception device 90 and the power transmission device 20 can be formed.

The power reception coil 91 is connected to the power reception resonant circuit 921. The power reception resonant circuit 921 has variable capacitance. Power output terminals of the power reception resonant circuit 921 are connected to input terminals of the rectifier circuit 922.

Output terminals of the rectifier circuit 922 are connected to input terminals of the smoothing circuit 923. Output terminals of the smoothing circuit 923 are connected to the output voltage conversion circuit 93 and the secondary battery 991. Output terminals of the output voltage conversion circuit 93 are output terminals of the power reception device 90 and are connected to the load ZL.

The power reception control circuit 94 is a digital control circuit, such as an MPU. The power reception control circuit 94 includes a resonance modulation control output terminal.

The resonance modulation control output terminal of the power reception control circuit 94 is connected to the resonance modulation circuit 924. The resonance modulation circuit 924 is connected to the power reception resonant circuit 921.

The power reception control circuit 94 is connected to an output terminal of the smoothing circuit 923 via the regulator 940.

### (Power Transmission and Reception Control)

As described in detail later, signal information regarding wireless power supply is transmitted from the power reception device 90 to the power transmission device 20 using resonance modulation and resonance demodulation. An electric current flowing through the high-side transmission line in the power transmission device 20 changes according to the signal information.

The power transmission control circuit 50 analyzes the signal information from the power reception device 90 using an output voltage waveform (or a current detection voltage waveform) of the current detection circuit 60. The power transmission control circuit 50 determines whether to permit power transmission based on the signal information. When permitting power transmission, the power transmission control circuit 50 generates a setting value for power transmission control to transmit power corresponding to the power reception device 90. The power transmission control circuit 50 outputs the setting value for power transmission control to the driver circuit 41.

The driver circuit 41 generates switching control signals for controlling the switching of the high-side switching element Q421 and the low-side switching element Q422 at a predetermined switching frequency based on the setting value for power transmission control and outputs the switching control signals to the high-side switching element Q421 and the low-side switching element Q422.

The high-side switching element Q421 and the low-side switching element Q422 are controlled by the corresponding switching control signals received from the driver circuit 41.

Also, the power transmission control circuit 50 outputs a normal setting value to the current regulator circuit 70. The normal setting value sets an input current that is input to the power conversion circuit 42 in a normal state (that is, when NULL described later does not occur).

The current regulator circuit 70 generates, from an input voltage Vi, an input voltage and an input current that are input to the power conversion circuit 42 in the normal state based on the normal setting value and outputs the input voltage and the input current to the power conversion circuit 42.

The input voltage and the input current input to the power conversion circuit 42 in the normal state are preferably set based on the minimum power that is required for the power reception device 90 and determined according to the specification of the power reception device 90. Here, it is further preferable that the minimum power for this purpose is determined to have a margin such that the minimum power required for the power reception device 90 is still satisfied even if the positional relationship between the power transmission coil 30 and the power reception coil 91 changes slightly.

The power conversion circuit 42 supplies, via the power transmission resonant circuit 43 to the power transmission coil 30, a power transmission current with a predetermined frequency (switching frequency) that is generated by the switching operations (on-off operations) of the high-side switching element Q421 and the low-side switching element Q422 according to the input voltage and the input current in the normal state.

The power transmission coil 30 is excited by the power transmission current with the predetermined frequency and generates an alternating magnetic field with the predetermined frequency.

The power reception coil 91 is coupled to the alternating magnetic field generated by the power transmission coil 30 and generates a power reception current.

In this case, the power transmission coil 30 is set to have a predetermined power transmission resonant frequency together with the power transmission resonant circuit 43, and the power reception coil 91 is set to have a predetermined power reception resonant frequency together with the power reception resonant circuit 921. Also, the power transmission resonant frequency and the power reception resonant frequency are set to be substantially the same, and the power transmission resonant frequency is substantially the same as the switching frequency of the power conversion circuit 42.

With the above configuration, an electromagnetic resonance field with a predetermined frequency (the power transmission resonant frequency, the power reception resonant frequency) is generated between the power transmission coil 30 of the power transmission device 20 and the power reception coil 91 of the power reception device 90. Accordingly, the wireless power transfer system 10 can efficiently supply power from the power transmission device 20 to the power reception device 90.

The frequency for forming the electromagnetic resonance field, that is, the frequency for wireless power supply, is preferably in the ISM band and is preferably in the 6.78 MHz band or the 13.56 MHz band.

The rectifier circuit 922 rectifies a power reception current from the power reception coil 91 into a direct current, and the smoothing circuit 923 smooths the direct current. The direct current output from the smoothing circuit 923 is converted into a predetermined voltage at the output voltage conversion circuit 93, and the predetermined voltage is supplied to the load ZL. Also, the direct current output from the smoothing circuit 923 is used for charging the secondary battery 991.

The load ZL includes a load circuit that performs a predetermined electric circuit operation using power output from the power reception circuit 92 via the output voltage conversion circuit 93. The load circuit includes at least one of a sensing circuit, a signal processing circuit, and a wireless communication circuit. For example, when the power reception device 90 is an implantable medical device, the load ZL performs processes (e.g., sensing a signal obtained from the inside of the body, filtering and amplifying the sensed signal, and a wireless communication process using WiFi or Bluetooth (registered trademark)) performed by the implantable medical device.

Thus, the wireless power transfer system 10 can efficiently supply power from the power transmission device 20 to the power reception device 90 by forming an electromagnetic resonance field. With this configuration, the wireless power transfer system 10 can efficiently supply power to the load ZL connected to the power reception device 90 and efficiently charge the secondary battery 991 of the power reception device 90.

### (Communication)

The power reception control circuit 94 generates signal information regarding wireless power supply for the power transmission device 20 and outputs the signal information to the resonance modulation circuit 924. The resonance modulation circuit 924 changes the resonance condition of the power reception resonant circuit 921 based on a bit (“0”, “1”) represented by the signal information. With this configuration, the power reception circuit 92 achieves resonance modulation based on the signal information.

When such resonance modulation occurs, the state of electromagnetic field coupling between the power reception coil 91 and the power transmission coil 30 changes. As a result, the amplitude of the power transmission current flowing through the power transmission coil 30 changes. That is, the circuit consisting of the power transmission coil 30 and the power transmission resonant circuit 43 achieves resonance demodulation.

When the amplitude of the power transmission current changes due to resonance demodulation, the current flowing through the high-side transmission line of the power transmission device 20 changes.

The output voltage of the current detection circuit 60 is affected by the current flowing through the high-side transmission line. Therefore, the output voltage of the current detection circuit 60 changes as the current flowing through the high-side transmission line changes.

The power transmission control circuit 50 demodulates signal information by detecting this change. This achieves signal transmission from the power reception device 90 to the power transmission device 20. That is, the wireless power transfer system 10 can achieve signal transmission by resonance modulation and resonance demodulation using an electromagnetic resonance field.

(Example of Physical Structure of Wireless power transfer system 10)

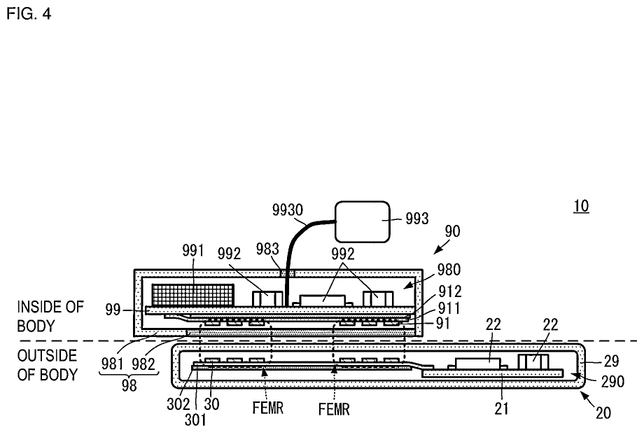

For example, the wireless power transfer system 10, which can perform wireless power supply and signal transmission as described above, can be applied to a system as illustrated in FIG. 4. FIG. 4 is a side cross-sectional view illustrating an example of a structure of the wireless power transfer system according to the embodiment of the present disclosure.

As illustrated in FIG. 4, the power reception device 90 of the wireless power transfer system 10 is embedded in a living body, and the power transmission device 20 is placed outside of the living body.

### (Structure of Power Reception Device 90)

The power reception device 90 includes a housing 98. The housing 98 is a sealed container with an internal space 980. The housing 98 is comprised of a biocompatible material. More specifically, the housing 98 includes a box-shaped first member 981 with an opening and a plate-shaped second member 982 that closes the opening of the first member 981. The first member 981 is comprised of a metal with biocompatibility, such as titanium or a titanium alloy. The second member 982 is comprised of a non-metallic material with biocompatibility, such as sapphire glass.

A circuit board 99, a power reception coil 91, an insulating film 911, a ferrite sheet 912, a secondary battery 991, and multiple electronic components 992 are arranged in the housing 98. The multiple electronic components 992 are, for example, mountable electronic components that implement the circuit configuration of the power reception device 90 described above.

The secondary battery 991 and the multiple electronic components 992 are mounted on a first surface of the circuit board 99. Also, a cable 9930 is connected to the first surface of the circuit board 99. The cable 9930 is connected to an electrode pad 993 outside of the housing 98 via a feedthrough formed in the first member 981 of the housing 98.

A power reception coil 91, an insulating film 911, and a ferrite sheet 912 are arranged on a second surface of the circuit board 99. More specifically, the ferrite sheet 912 is disposed on the second surface of the circuit board 99, and the power reception coil 91 having a flat film shape and supported by the insulating film 911 is disposed on a surface of the ferrite sheet 912 (that is opposite the second surface of the circuit board 99). The power reception coil 91 is connected to the electronic components 992 constituting the power reception circuit 92 through the circuit board 99.

The power reception coil 91 is disposed such that the flat film surface of the power reception coil 91 is in close proximity to the power reception surface of the housing 98 (the surface of the housing 98 including the second member 982) and that the flat film surface is substantially parallel to the power reception surface and overlaps the second member 982.

### (Structure of Power Transmission Device 20)

The power transmission device 20 includes a housing 29. The housing 29 has an internal space 290.

A circuit board 21, a power transmission coil 30, an insulating film 301, a ferrite sheet 302, and multiple electronic components 22 are arranged in the housing 29. The multiple electronic components 22 are, for example, mountable electronic components that implement the circuit configuration of the power transmission device 20 described above.

The multiple electronic components 22 are mounted on the circuit board 21. Also, the power transmission coil 30 having a flat film shape and supported by the insulating film 301 is connected to the circuit board 21. The ferrite sheet 302 is disposed opposite the power transmission coil 30 across the insulating film 301.

The power transmission coil 30 is disposed such that the flat film surface of the power transmission coil 30 is in close proximity to the power transmission surface of the housing 29 and that the flat film surface is substantially parallel to the power transmission surface.

(Positional Relationship between Power Transmission Device 20 and Power Reception Device 90 during Wireless Power Supply)

As illustrated in FIG. 4, during wireless power supply, the power reception device 90 is placed on the power transmission device 20 such that the power reception surface is substantially parallel to the power transmission surface and closely faces the power transmission surface. In this state, the power transmission coil 30 of the power transmission device 20 and the power reception coil 91 of the power reception device 90 are positioned to substantially face each other.

With this positional relationship, the power transmission device 20 and the power reception device 90 generate an electromagnetic resonance field as described above and achieve wireless power supply. Also, the power reception device 90 and the power transmission device 20 achieve signal transmission using resonance modulation and resonance demodulation.

(Method of Preventing Occurrence of NULL during Communication)

As described above, in communication performed at the same time as wireless power supply, there is a state in which communication cannot be performed (or a state in which NULL occurs) even within a range in which power necessary for communication can be received.

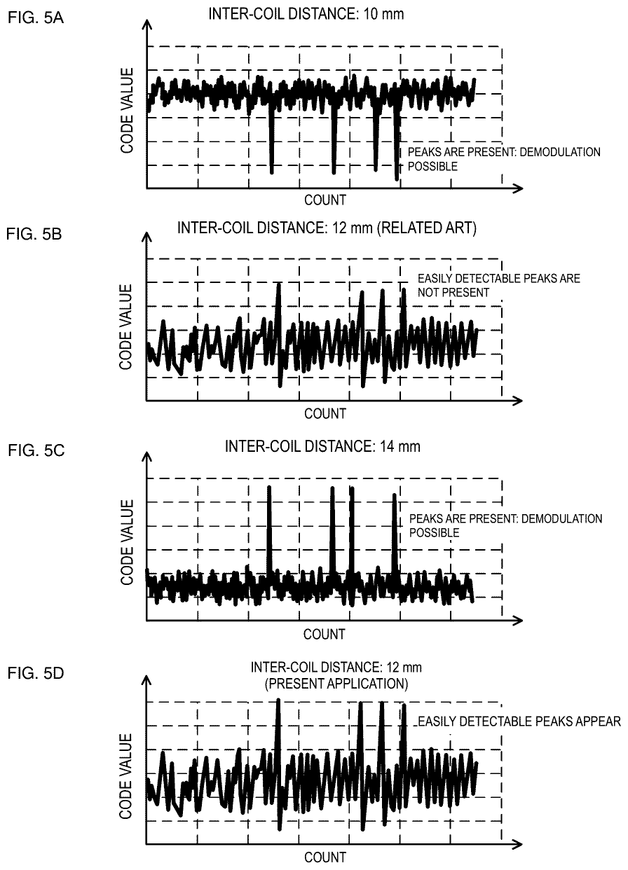

FIGS. 5A, 5B, 5C, and 5D are diagrams showing waveforms during demodulation. In each of FIGS. 5A, 5B, 5C, and 5D, the horizontal axis indicates a count that corresponds to time, and the vertical axis indicates a code value that corresponds to the amplitude of a current flowing through the high-side transmission line.

FIGS. 5A, 5B, and 5C show examples in which power supply is performed in the normal state described above while changing the distance between the power transmission coil and the power reception coil. FIG. 5D shows an example in which a control process according to the present disclosure is performed when NULL occurs during power supply in the normal state.

When performing power supply in the normal state as shown in FIG. 5A, FIG. 5B, and FIG. 5C, at distances other than a specific distance, peaks modulated according to signal information are sufficiently higher than noise and can be detected to enable demodulation as shown in FIG. 5A and FIG. 5C.

However, at a specific distance, as shown in FIG. 5B, the difference between the heights of peaks modulated according to signal information and the height of noise is small (NULL occurs), making it difficult to detect the peaks and perform demodulation. This phenomenon tends to occur when a metal is present in the vicinity of the power transmission coil 30 and the power reception coil 91. For example, this phenomenon tends to occur when power is being supplied to an implantable medical device with a metal housing as illustrated in FIG. 4.

To solve this problem, when peaks cannot be detected, the power transmission control circuit 50 of the power transmission device 20 generates instruction data for causing the current regulator circuit 70 to change the input current to the power conversion circuit 42 and outputs the instruction data to the current regulator circuit 70. The current regulator circuit 70 controls the input current to the power conversion circuit 42 within a range in which wireless power transmission can be performed stably.

For example, when peaks cannot be detected, the power transmission control circuit 50 generates instruction data to change the input current to the power conversion circuit 42 to a level higher than the input current in the normal state and outputs the instruction data to the current regulator circuit 70.

The current regulator circuit 70 increases the input current to the power conversion circuit 42 based on the instruction data.

With this control process, as shown in FIG. 5D, peaks modulated according to the signal information become sufficiently higher than noise without changing the distance between the power transmission coil 30 and the power reception coil 91. With this configuration, the power transmission control circuit 50 can detect peaks and perform demodulation.

Thus, by using the wireless power transfer system 10 of the present embodiment, when communication is performed together with wireless power supply, it is possible to prevent the occurrence of NULL and to stably perform signal transmission within a distance range where power can be supplied.

Here, when the power reception device 90 is an implantable medical device, the position of the power reception device 90 cannot be easily changed. Even in such a case, the wireless power transfer system 10 can prevent the occurrence of NULL by performing the above-described control process. Accordingly, even for an implantable medical device, the wireless power transfer system 10 can stably perform signal transmission within a distance range where power can be supplied.

In the above descriptions, the wireless power transfer system 10 prevents NULL by setting the input current in the normal state at a minimum necessary level and increasing the input current when NULL occurs. Alternatively, the wireless power transfer system 10 may also be configured to prevent NULL by setting the input current in the normal state at a relatively high level and decreasing the input current within a range where power can be supplied when NULL occurs.

However, by setting the input current in the normal state at a minimum necessary level and increasing the input current to prevent NULL, the wireless power transfer system 10 can achieve stable wireless power supply and signal transmission while minimizing supply power. Also, minimizing the supply power makes it possible to suppress heat generated by the power reception current in the power reception device 90. When the power reception device 90 is an implantable medical device, this makes it possible to suppress the adverse effect of the heat on the living body.

Furthermore, this makes it possible to reduce noise during the rectification of the power reception current and thereby makes it possible to suppress adverse effects caused by the noise on electronic components in the power reception device 90, particularly, adverse effects on the sensing of biological signals in the case of an implantable medical device.

### (First Example of Configuration of Current Regulator Circuit)

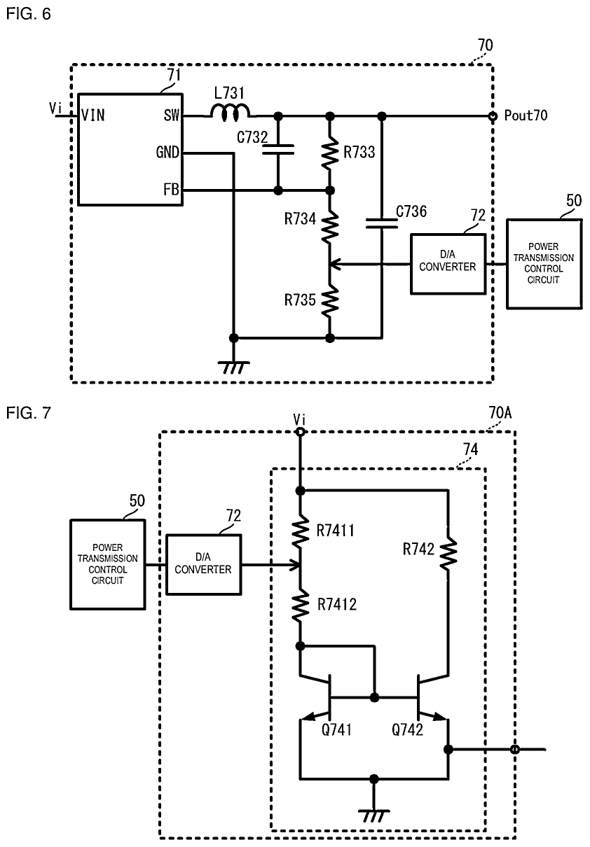

FIG. 6 is a diagram illustrating a first example of a current regulator circuit according to the embodiment of the present disclosure. As illustrated in FIG. 6, the current regulator circuit 70 includes a DC-DC converter 71, a D/A converter 72, an inductor L731, a capacitor C732, resistors R733, R734, and R735, and a capacitor C736.

The DC-DC converter 71 includes an input terminal VIN, an output terminal SW, a ground terminal GND, and a feedback terminal FB. The input terminal VIN is connected to the high-side transmission line, and the ground terminal GND is connected to the reference potential (ground potential) of the power transmission device 20.

The DC-DC converter 71 converts a direct-current input voltage Vi at the input terminal VIN into a predetermined direct-current voltage based on a voltage at the feedback terminal FB and outputs the predetermined direct-current voltage.

The inductor L731 is connected between the output terminal SW of the DC-DC converter 71 and an output terminal Pout70 of the current regulator circuit 70. The capacitor C732 is connected between the feedback terminal FB and the node between the inductor L731 and the output terminal Pout70.

The resistors R733, R734, and R735 are connected in series in this order between the reference potential and the node between the inductor L731 and the output terminal Pout70. The node between the resistor R733 and the resistor R734 is connected to the feedback terminal FB.

The capacitor C736 is connected between the reference potential and the node between the inductor L731 and the output terminal Pout70.

The digital input terminal of the D/A converter 72 is connected to the power transmission control circuit 50. The analog output terminal of the D/A converter 72 is connected to the node between the resistors R734 and R735.

In this configuration, the power transmission control circuit 50 inputs setting value data for current adjustment to the D/A converter 72. The D/A converter 72 applies an output voltage corresponding to the setting value data for current adjustment to the node between the resistors R734 and R735. As a result, the voltage at the feedback terminal FB of the DC-DC converter 71 becomes a value corresponding to the output voltage that corresponds to the setting value data.

Accordingly, the power transmission control circuit 50 can adjust the voltage at the feedback terminal FB to prevent NULL by changing the setting value data from a value for the normal state to a value for the prevention of NULL.

As a result, the output voltage of the DC-DC converter 71 is adjusted from a voltage for the normal state to a voltage for the prevention of NULL, and the input current for the power conversion circuit 42 is adjusted from a current for the normal state to a current for the prevention of NULL.

Thus, when performing communication together with wireless power supply, the wireless power transfer system 10 can more stably perform communication within a distance range where power can be supplied.

Also, the current regulator circuit 70 can adjust the input voltage to the power conversion circuit 42 according to the setting value from the power transmission control circuit 50 and thereby adjust the input current to the power conversion circuit 42. With this configuration, the wireless power transfer system 10 can increase the input current to the power conversion circuit 42 without using an additional current supply circuit for supplying a current to the power conversion circuit 42.

### (Second Example of Configuration of Current Regulator Circuit)

FIG. 7 is a diagram illustrating a second example of a current regulator circuit according to the embodiment of the present disclosure. As illustrated in FIG. 7, a current regulator circuit 70A includes a D/A converter 72 and a current mirror circuit 74. The current mirror circuit 74 includes resistors R7411, R7412, and R742, an npn transistor Q741, and an npn transistor Q742 and implements a constant-current circuit.

The base terminal of the transistor Q741 is connected to the base terminal of the transistor Q742. The node between these base terminals is connected to the collector terminal of the transistor Q741. The emitter terminals of the transistor Q741 and the transistor Q742 are connected to the reference potential.

The collector terminal of the transistor Q741 is connected to the high-side transmission line via the resistors R7412 and R7411. The collector terminal of the transistor Q742 is connected to the high-side transmission line via the resistor R742.

The emitter terminal of the transistor Q742 is connected to the high-side input terminal of the power conversion circuit 42.

The digital input terminal of the D/A converter 72 is connected to the power transmission control circuit 50. The analog output terminal of the D/A converter 72 is connected to the node between the resistor R7411 and the resistor R7412.

With this configuration, the current regulator circuit 70A can decrease the input current to the power conversion circuit 42 according to a voltage from the D/A converter 72.

Also, this configuration makes it possible to simplify the circuit configuration of the current regulator circuit 70A and thereby simplify the circuitry of the power transmission device 20.

### (Example of Configuration of Current Detection Circuit)

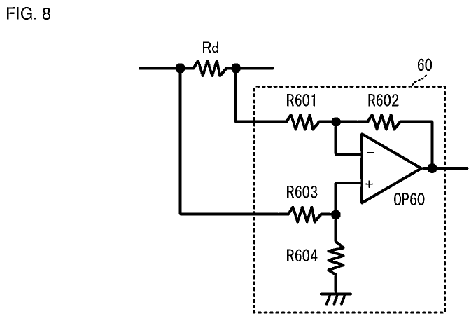

FIG. 8 is a diagram illustrating an example of a current detection circuit according to the embodiment of the present disclosure. As illustrated in FIG. 8, the current detection circuit 60 is implemented by a differential amplifier circuit. Specifically, the current detection circuit 60 includes an operational amplifier OP60 and resistors R601, R602, R603, and R604.

The inverting input terminal of the operational amplifier OP60 is connected via the resistor R601 to the output side (a side closer to the current regulator circuit 70) of the current detection resistor Rd.

The non-inverting input terminal of the operational amplifier OP60 is connected via the resistor R603 to the input side (a side closer to the input filter 202) of the current detection resistor Rd. Also, the non-inverting input terminal of the operational amplifier OP60 is connected via the resistor R604 to the reference potential.

The output terminal of the operational amplifier OP60 is connected via the resistor R602 to the inverting input terminal.

With this configuration, the current detection circuit 60 outputs, to the power transmission control circuit 50, a current detection voltage corresponding to the voltage between the ends of the current detection resistor Rd that is generated by a current flowing through the current detection resistor Rd.

With this configuration, the power transmission device 20 converts a current obtained by resonance modulation and resonance demodulation into a voltage and amplifies the voltage so that the current can be detected more reliably and stably. Thus, the power transmission device 20 can improve the accuracy of detecting NULL and can more reliably prevent NULL. Accordingly, the wireless power transfer system 10 can more stably perform signal transmission within a distance range where power can be supplied.

<1> A wireless power transfer system includes a power reception device and a power transmission device. The wireless power transfer system performs wireless power supply by forming an electromagnetic resonance field between the power transmission device and the power reception device and performs signal transmission by resonance modulation using the electromagnetic resonance field. The power reception device includes a housing having an internal space, a power reception coil that is disposed in the internal space and performs wireless power reception by forming the electromagnetic resonance field, a power reception circuit including a power reception resonant circuit and a resonance modulation circuit that performs the resonance modulation, and a load circuit that performs a predetermined electric circuit operation using output power of the power reception circuit. The power transmission device includes a power transmission coil that performs wireless power transmission by forming the electromagnetic resonance field, a power transmission circuit including a power transmission resonant circuit, a power transmission control circuit, a resonance demodulation circuit that performs resonance demodulation corresponding to the resonance modulation, a current detection circuit that detects an input current to the power transmission circuit, and a current regulator circuit that adjusts the input current. The power transmission device detects, by using the current detection circuit, a state in which a signal generated by the resonance modulation and received from the power reception circuit is undetectable. When the signal is undetectable, the power transmission device changes the input current by using the current regulator circuit to prevent the state in which the signal is undetectable and thereby stabilize an operation of the resonance demodulation.

<2 The wireless power transfer system described in <1>. The current regulator circuit changes the input current by changing an input voltage supplied to the power transmission circuit.

<3> The wireless power transfer system described in <1> or <2>. The housing of the power reception device is formed of a biocompatible material, the power reception device is embedded in a living body, and the power transmission device is disposed outside of the living body.

<4> The wireless power transfer system described in <3>. The biocompatible material is titanium or a titanium alloy.

<5> The wireless power transfer system described in any one of <1> to <4>. The current regulator circuit controls the input current within a range in which the wireless power transmission is performed.

<6> The wireless power transfer system described in any one of <1> to <5>. The range in which the wireless power transmission is performed is a range in which power in the wireless power transmission is greater than or equal to a predetermined value.

<7> The wireless power transfer system described in any one of <1> to <6>. The frequency of the wireless power supply is in a 6.78 MHz band or a 13.56 MHz band.

<8> The wireless power transfer system described in any one of <1> to <7>. The load circuit includes a sensing circuit, a signal processing circuit, and a wireless communication circuit.

<9> The wireless power transfer system described in any one of <1> to <8>. The current regulator circuit includes a DC-DC converter and a D/A converter. The power transmission control circuit adjusts an input voltage by outputting a setting value to the D/A converter and thereby varying a feedback voltage of the DC-DC converter.

<10> The wireless power transfer system described in any one of <1> to <9>. The current regulator circuit includes a constant-current circuit using a current mirror and sets the input current by using the power transmission control circuit.

<11> The wireless power transfer system described in any one of <1> to <10>. The current detection circuit includes a shunt resistor connected to a line through which the input current flows, and a voltage amplifier that amplifies a voltage obtained from a voltage generated at the ends of the shunt resistor.

<12> A power transmission device of a wireless power transfer system that performs wireless power supply for a power reception device by forming an electromagnetic resonance field and performs signal transmission by resonance modulation using the electromagnetic resonance field. The power transmission device includes a power transmission coil that performs wireless power transmission by forming the electromagnetic resonance field, a power transmission circuit including a power transmission resonant circuit, a power transmission control circuit, a resonance demodulation circuit that performs resonance demodulation corresponding to the resonance modulation, a current detection circuit that detects an input current to the power transmission circuit, and a current regulator circuit that adjusts the input current. The power transmission device detects, by using the current detection circuit, a state in which a signal generated by the resonance modulation and received from the power reception device is undetectable. When the signal is undetectable, the power transmission device changes the input current by using the current regulator circuit to prevent the state in which the signal is undetectable and thereby stabilize an operation of the resonance demodulation.

<13> The power transmission device of the wireless power transfer system described in <12>. The current regulator circuit controls the input current within a range in which the wireless power transmission is performed.

<14> The power transmission device of the wireless power transfer system described in <12> or <13>. The range in which the wireless power transmission is performed is a range in which power in the wireless power transmission is greater than or equal to a predetermined value.

<15> The power transmission device of the wireless power transfer system described in any one of <12> to <14>. The frequency of the wireless power supply is in a 6.78 MHz band or a 13.56 MHz band.

<16> The power transmission device of the wireless power transfer system described in any one of <12> to <15>. The current regulator circuit includes a DC-DC converter, a D/A converter, and a digital control circuit. The digital control circuit adjusts an input voltage by outputting a setting value to the D/A converter and thereby varying a feedback voltage of the DC-DC converter.

<17> The power transmission device of the wireless power transfer system described in any one of <12> to <16>. The current regulator circuit includes a constant-current circuit using a current mirror and sets the input current by using the power transmission control circuit.

<18> The power transmission device of the wireless power transfer system described in any one of <12> to <17>. The current detection circuit includes a shunt resistor connected to a line through which the input current flows, and a voltage amplifier that amplifies a voltage obtained from a voltage generated at the ends of the shunt resistor.

What is claimed is:

1. A wireless power transfer system comprising:
a power reception device; and
a power transmission device, wherein
the wireless power transfer system is configured to perform wireless power supply by generating an electromagnetic resonance field between the power transmission device and the power reception device and perform signal transmission by resonance modulation using the electromagnetic resonance field;
the power reception device includes
a housing having an internal space,
a power reception coil that is in the internal space and configured to perform wireless power reception by generating the electromagnetic resonance field,
a power reception circuit including a power reception resonant circuit and a resonance modulation circuit that is configured to perform the resonance modulation, and
a load circuit that is configured to perform a predetermined electric circuit operation using output power of the power reception circuit;
the power transmission device includes
a power transmission coil that is configured to perform wireless power transmission by generating the electromagnetic resonance field,
a power transmission circuit including a power transmission resonant circuit,
a power transmission control circuit,
a resonance demodulation circuit that is configured to perform resonance demodulation corresponding to the resonance modulation,
a current detection circuit that is configured to detect an input current to the power transmission circuit, and
a current regulator circuit that is configured to adjust the input current; and
the power transmission device is configured to
detect, by using the current detection circuit, a state in which a signal generated by the resonance modulation and received from the power reception circuit is undetectable, and
when the signal is undetectable, change the input current by using the current regulator circuit to prevent the state in which the signal is undetectable and thereby stabilize an operation of the resonance demodulation.

2. The wireless power transfer system according to claim 1, wherein
the current regulator circuit is configured to change the input current by changing an input voltage supplied to the power transmission circuit.

3. The wireless power transfer system according to claim 1, wherein
the housing of the power reception device includes a biocompatible material,
the power reception device is embedded in a living body, and
the power transmission device is outside of the living body.

4. The wireless power transfer system according to claim 3, wherein
the biocompatible material is titanium or a titanium alloy.

5. The wireless power transfer system according to claim 1, wherein
the current regulator circuit is configured to control the input current within a range in which the wireless power transmission is performed.

6. The wireless power transfer system according to claim 1, wherein
a range in which the wireless power transmission is performed is a range in which power in the wireless power transmission is greater than or equal to a predetermined value.

7. The wireless power transfer system according to claim 1, wherein
a frequency of the wireless power supply is in a 6.78 MHz band or a 13.56 MHz band.

8. The wireless power transfer system according to claim 1, wherein
the load circuit includes a sensing circuit, a signal processing circuit, and a wireless communication circuit.

9. The wireless power transfer system according to claim 1, wherein
the current regulator circuit includes a DC-DC converter and a D/A converter; and
the power transmission control circuit adjusts an input voltage by outputting a setting value to the D/A converter and thereby varying a feedback voltage of the DC-DC converter.

10. The wireless power transfer system according to claim 1, wherein
the current regulator circuit includes a constant-current circuit using a current mirror and is configured to set the input current by using the power transmission control circuit.

11. The wireless power transfer system according to claim 1, wherein
the current detection circuit includes
a shunt resistor connected to a line through which the input current flows, and
a voltage amplifier configured to amplify a voltage obtained from a voltage generated at ends of the shunt resistor.

12. The wireless power transfer system according to claim 1, wherein
the housing of the power reception device includes a biocompatible material,
the power reception device is embedded in a living body, and
the power transmission device is outside of the living body.

13. The wireless power transfer system according to claim 2, wherein
the current regulator circuit is configured to control the input current within a range in which the wireless power transmission is performed.

14. A power transmission device of a wireless power transfer system that is configured to perform wireless power supply for a power reception device by generating an electromagnetic resonance field and perform signal transmission by resonance modulation using the electromagnetic resonance field, the power transmission device comprising:
a power transmission coil that is configured to perform wireless power transmission by generating the electromagnetic resonance field;
a power transmission circuit including a power transmission resonant circuit;
a power transmission control circuit;
a resonance demodulation circuit that is configured to perform resonance demodulation corresponding to the resonance modulation;
a current detection circuit that is configured to detect an input current to the power transmission circuit; and
a current regulator circuit that is configured to adjust the input current, wherein
the power transmission device is configured to
detect, by using the current detection circuit, a state in which a signal generated by the resonance modulation and received from the power reception device is undetectable, and
when the signal is undetectable, change the input current by using the current regulator circuit to prevent the state in which the signal is undetectable and thereby stabilize an operation of the resonance demodulation.

15. The power transmission device of the wireless power transfer system according to claim 14, wherein
the current regulator circuit is configured to control the input current within a range in which the wireless power transmission is performed.

16. The power transmission device of the wireless power transfer system according to claim 14, wherein
a range in which the wireless power transmission is performed is a range in which power in the wireless power transmission is greater than or equal to a predetermined value.

17. The power transmission device of the wireless power transfer system according to claim 14, wherein
a frequency of the wireless power supply is in a 6.78 MHz band or a 13.56 MHz band.

18. The power transmission device of the wireless power transfer system according to claim 14, wherein
the current regulator circuit includes a DC-DC converter, a D/A converter, and a digital control circuit; and
the digital control circuit is configured to set an input voltage by outputting a setting value to the D/A converter and thereby varying a feedback voltage of the DC-DC converter.

19. The power transmission device of the wireless power transfer system according to claim 14, wherein
the current regulator circuit includes a constant-current circuit using a current mirror and is configured to set the input current by using the power transmission control circuit.

20. The power transmission device of the wireless power transfer system according to claim 14, wherein
the current detection circuit includes
a shunt resistor connected to a line through which the input current flows, and
a voltage amplifier configured to amplify a voltage obtained from a voltage generated at ends of the shunt resistor.
